(19) United States
(12) Patent Application Publication
(10) Pub. No.: US 2024/0426383 A1
(43) Pub. Date: Dec. 26, 2024

(54) APPARATUS FOR SAFETY SHUT-OFF VALVE

(71) Applicant: Douglas C. Baynes, Marietta, GA (US)

(72) Inventor: Douglas C. Baynes, Marietta, GA (US)

(21) Appl. No.: 18/214,130

(22) Filed: Jun. 26, 2023

(51) Int. Cl. F16K 5/10; F16K 31/60; F17C 13/04

(52) U.S. Cl. CPC F16K 5/103; F16K 31/602; F17C 13/04

(57) ABSTRACT

The present variations disclose an apparatus for controlling fluid flow including funnel defining a first flow passage therethrough; a flow control valve defining a second flow passage in fluid communication with the first flow passage; and an attachment cap removably connected to the flow control valve, the attachment cap defining a third flow passage in fluid communication with the second flow passage and the first flow passage.

### TECHNICAL FIELD

The embodiments generally relate to apparatus' for controlling fluid flow.

### BACKGROUND

Apparatus' for controlling fluid flow fail to provide a means to easily start and stop the flow of fluid without spillage.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The disclosure generally relates to an apparatus for controlling fluid flow including funnel defining a first flow passage therethrough; a flow control valve defining a second flow passage in fluid communication with the first flow passage; and an attachment cap removably connected to the flow control valve, the attachment cap defining a third flow passage in fluid communication with the second flow passage.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 includes an illustration of an apparatus for safety shut-off valve;

FIG. 2 includes an illustration of an apparatus for safety shut-off valve;

FIG. 3 includes an illustration of a portion of an apparatus for safety shut-off valve;

FIG. 4 includes an illustration of an apparatus for safety shut-off valve;

FIG. 5 includes an illustration of an apparatus for safety shut-off valve.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

The embodiments generally relate to an apparatus for includes an apparatus including a universal safety shut-off valve. The shut-off valve is attached to a spout that is designed to fit on any universal fluid container, such as a universal gas can. The positioning of the shut-off valve allows for a user to hold a gasoline can with one hand and use the other hand to easily place the spout inside a receiving container. With one hand holding the gasoline can, the user can turn the shut-off valve to the “open” position with the other hand without comprising the stability of holding the gasoline can. To stop, user can simply turn the shut-off valve to the “closed” position and remove the spout without spillage.

The embodiments generally relate to an apparatus including an attachment cap, funnel, and flow control valve positioned there between.

The attachment cap may be configured to attach to the flow control valve and a fluid container, such as a gasoline container. The attachment cap may threadingly attach to the flow control valve and the fluid container. According to some embodiments, the attachment cap may attach to the flow control valve and the fluid container by mean other than threading.

The funnel may define a flow passage therethrough and may be in fluid communication with the flow control valve. According to some variations, the funnel may include flexing ribs constructed and arranged to allow for flexing of the funnel to facilitate directed flow of fluid.

The flow control valve may be constructed and arranged to control the flow of fluid therethrough and into the funnel. The flow control valve may include an actuator that can be turned to open or close the valve partially or completely. The flow control valve may include a main housing that contains the internal components and provides the connection points for fluid entry and exit. The flow control valve may include a flow passage as the internal pathway through which the fluid flows. The flow passage may be adjusted to restrict or allow more flow by altering the valve position. The flow control valve may include an actuator responsible for adjusting the valve position. The actuator can be a handle, knob, solenoid, or other actuation methods, depending on the valve type. The flow control valve may include a flow adjustment mechanism that controls the flow rate. The flow adjustment mechanism may be a needle valve, a spool, or other designs that restrict or allow fluid passage. The flow control valve's design and operation may vary depending on construction and application.

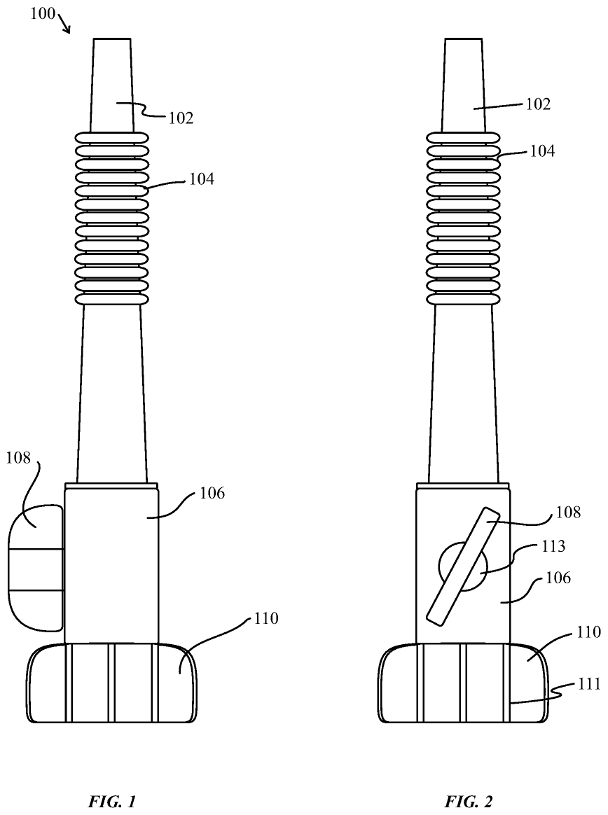

FIGS. 1 and 2 include illustrations of an apparatus for safety shut-off valve 100 including a funnel 102 including flexible ribs 104. The funnel 102 may be removably attached to a flow control valve 106 including a valve handle 108 and stem actuator 113. The flow control valve 106 may be removably attached to an attachment cap 110 having ridges 111 thereon. FIG. 2 depicts an apparatus for safety shut-off valve 100 rotated relative to FIG. 1 to show the valve handle 108.

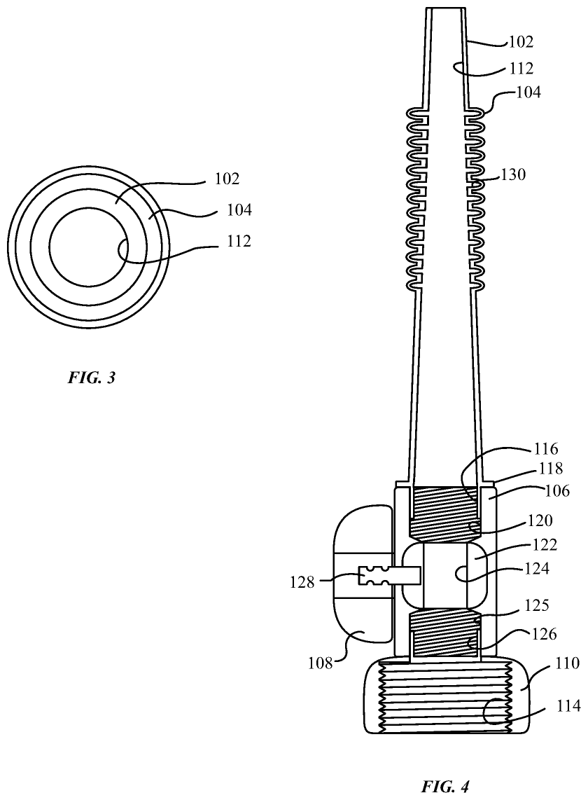

FIG. 3 illustrates a top-down view of the funnel 102 defining a flow passage 112 and including a plurality of flexible ribs 104.

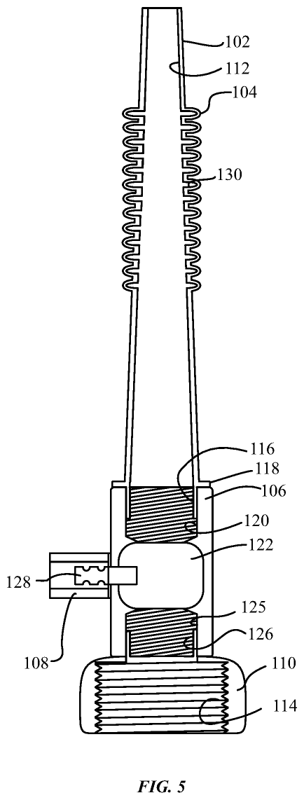

FIG. 4 illustrates a cross-sectional view of an apparatus for safety shut off valve 100 in an open position including a final 102 defining a flow passage 112 therein and including a plurality of flexible ribs 104. The plurality of flexible ribs 104 and the flow passage 112 may define rib recesses 130 to facilitate non turbulent flow of fluid through the funnel 102 and improve flexibility of the funnel 102. The funnel 102 may include a connecting end 118 constructed and arranged to engage with a flow control valve 106, such as via a threading neck 116 which may threateningly engage but they first threaded outlet 120 of the flow control valve 106. The flow control valve 106 may include a flow adjustment mechanism 102 defining a flow passage 124 therein and which may be mechanically connected to a valve stem 128 and valve handle 108. The flow control valve 106 may include a threaded inlet 125 mechanically attachable to a second threaded neck 126 of an attachment cap 110. The attachment cap 110 may include a third threaded neck 114 for attaching the attachment cap 110 to a container.

FIG. 5 illustrates a cross-sectional view of an apparatus for safety shut off valve 100 in an closed position including a final 102 defining a flow passage 112 therein and including a plurality of flexible ribs 104. The plurality of flexible ribs 104 and the flow passage 112 may define rib recesses 130 to facilitate non turbulent flow of fluid through the funnel 102 and improve flexibility of the funnel 102. The funnel 102 may include a connecting end 118 constructed and arranged to engage with a flow control valve 106, such as via a threading neck 116 which may threateningly engage but they first threaded outlet 120 of the flow control valve 106. The flow control valve 106 may include a flow adjustment mechanism 102 defining a flow passage 124 therein and which may be mechanically connected to a valve stem 128 and valve handle 108. The flow control valve 106 may include a threaded inlet 125 mechanically attachable two way second threaded neck 126 of an attachment cap 110. The attachment cap 110 may include a third threaded neck 114 for attaching the attachment cap 110 to a container.

The following description of variants is only illustrative of components, elements, acts, product, and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

According to variation 1, an apparatus for safety shut off valve may include a funnel defining a first flow passage therethrough; a flow control valve defining a second flow passage in fluid communication with the first flow passage; and an attachment cap removably connected to the flow control valve, the attachment cap defining a third flow passage in fluid communication with the second flow passage.

Variation 2 may include apparatus for safety shut off valve as in variation 1, wherein the funnel further includes a plurality of flexible ribs.

Variation 3 may include apparatus for safety shut off valve as in variation 1 or 2, wherein the plurality of flexible ribs define a plurality of rib recesses.

Variation 4 may include apparatus for safety shut off valve as in any of variations 1 through 3, wherein the plurality of flexible ribs are constructed and arranged to facilitate flexion of the funnel.

Variation 5 may include apparatus for safety shut off valve as in any of variations 1 through 4, wherein the plurality of flexible ribs are constructed and arranged to facilitate non-turbulent flow of fluid through the funnel.

Variation 6 may include apparatus for safety shut off valve as in any of variations 1 through 5, wherein the funnel is flexible.

Variation 7 may include apparatus for safety shut off valve as in any of variations 1 through 6, wherein the funnel includes a first connecting end constructed and arranged to attach to the flow control valve.

Variation 8 may include apparatus for safety shut off valve as in any of variations 1 through 7, wherein the flow control valve includes a flow adjustment mechanism defining a flow passage therein and which is mechanically connected to a valve stem and a valve handle.

Variation 9 may include apparatus for safety shut off valve as in any of variations 1 through 8, wherein the attachment cap includes a third threaded neck configured for attaching the attachment cap to a container.

According to variation 10, an apparatus for safety shut off valve may include a flexible funnel defining a first flow passage therethrough and including a plurality of flexible ribs, and including a first connecting end constructed and arranged to attach to a flow control valve; a flow control valve defining a second flow passage in fluid communication with the first flow passage. and including a flow adjustment mechanism defining a flow passage therein and which is mechanically connected to a valve stem and a valve handle; and an attachment cap removably connected to the flow control valve, the attachment cap defining a third flow passage in fluid communication with the second flow passage.

Variation 11 may include an apparatus for safety shut off valve as in variation 10, wherein the plurality of flexible ribs define a plurality of rib recesses.

Variation 12 may include apparatus for safety shut off valve as in variation 10 or 11, wherein the plurality of flexible ribs are constructed and arranged to facilitate flexion of the funnel.

Variation 13 may include apparatus for safety shut off valve as in any of variations 10 through 12 wherein the plurality of flexible ribs are constructed and arranged to facilitate non-turbulent flow of fluid through the funnel.

Variation 14 may include apparatus for safety shut off valve as in any of variations 10 through 13 wherein the attachment cap includes a third threaded neck configured for attaching the attachment cap to a container.

According to variation 15, an apparatus for safety shut off valve may include a flexible funnel defining a first flow passage therethrough and including a plurality of flexible ribs defining a plurality of rib recesses, and including a first connecting end constructed and arranged to attach to a flow control valve; a flow control valve removably connected to the flexible funnel, the flow control valve defining a second flow passage in fluid communication with the first flow passage. and including a flow adjustment mechanism defining a flow passage therein and which is mechanically connected to a valve stem and a valve handle; and an attachment cap removably connected to the flow control valve, the attachment cap defining a third flow passage in fluid communication with the second flow passage.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. An apparatus for safety shut off valve, comprising:
a funnel defining a first flow passage therethrough;
a flow control valve defining a second flow passage in fluid communication with the first flow passage; and
an attachment cap removably connected to the flow control valve, the attachment cap defining a third flow passage in fluid communication with the second flow passage.

2. An apparatus for safety shut off valve as in claim 1, wherein the funnel further comprises a plurality of flexible ribs.

3. An apparatus for safety shut off valve as in claim 2, wherein the plurality of flexible ribs define a plurality of rib recesses.

4. An apparatus for safety shut off valve as in claim 2, wherein the plurality of flexible ribs are constructed and arranged to facilitate flexion of the funnel.

5. An apparatus for safety shut off valve as in claim 2, wherein the plurality of flexible ribs are constructed and arranged to facilitate non-turbulent flow of fluid through the funnel.

6. An apparatus for safety shut off valve as in claim 1, wherein the funnel is flexible.

7. An apparatus for safety shut off valve as in claim 1, wherein the funnel comprises a first connecting end constructed and arranged to attach to the flow control valve.

8. An apparatus for safety shut off valve as in claim 1, wherein the flow control valve comprises a flow adjustment mechanism defining a flow passage therein and which is mechanically connected to a valve stem and a valve handle.

9. An apparatus for safety shut off valve as in claim 1, wherein the attachment cap comprises a third threaded neck configured for attaching the attachment cap to a container.

10. An apparatus for safety shut off valve, comprising:
a flexible funnel defining a first flow passage therethrough and comprising a plurality of flexible ribs, and comprising a first connecting end constructed and arranged to attach to a flow control valve;
a flow control valve defining a second flow passage in fluid communication with the first flow passage. and comprising a flow adjustment mechanism defining a flow passage therein and which is mechanically connected to a valve stem and a valve handle; and
an attachment cap removably connected to the flow control valve, the attachment cap defining a third flow passage in fluid communication with the second flow passage.

11. An apparatus for safety shut off valve as in claim 10, wherein the plurality of flexible ribs define a plurality of rib recesses.

12. An apparatus for safety shut off valve as in claim 10, wherein the plurality of flexible ribs are constructed and arranged to facilitate flexion of the funnel.

13. An apparatus for safety shut off valve as in claim 10, wherein the plurality of flexible ribs are constructed and arranged to facilitate non-turbulent flow of fluid through the funnel.

14. An apparatus for safety shut off valve as in claim 10, wherein the attachment cap comprises a third threaded neck configured for attaching the attachment cap to a container.

15. An apparatus for safety shut off valve, comprising:
a flexible funnel defining a first flow passage therethrough and comprising a plurality of flexible ribs defining a plurality of rib recesses, and comprising a first connecting end constructed and arranged to attach to a flow control valve;
a flow control valve removably connected to the flexible funnel, the flow control valve defining a second flow passage in fluid communication with the first flow passage. and comprising a flow adjustment mechanism defining a flow passage therein and which is mechanically connected to a valve stem and a valve handle; and
an attachment cap removably connected to the flow control valve, the attachment cap defining a third flow passage in fluid communication with the second flow passage.
